(19) United States
(12) Patent Application Publication
(10) Pub. No.: US 2020/0387948 A1
(43) Pub. Date: Dec. 10, 2020

(54) SYSTEMS AND METHODS FOR PROVIDING CUSTOMIZED IN-STORE NAVIGATION

(71) Applicant: Wells Fargo Bank, N.A., San Francisco, CA (US)

(72) Inventors: Ashish B. Kurani, Burlingame, CA (US); Nikolai Stroke, Gilbert, AZ (US)

(21) Appl. No.: 14/885,482

(22) Filed: Oct. 16, 2015

Related U.S. Application Data
(60) Provisional application No. 62/195,102, filed on Jul. 21, 2015.

(51) Int. Cl. G06Q 30/06; G06Q 30/02

(52) U.S. Cl. CPC G06Q 30/0631; G06Q 30/0222; G06Q 30/0639; G06Q 30/0635

(57) ABSTRACT

A computer-implemented method for providing customized in-store navigation includes receiving, by an in-store navigation computer system, a shopping list from a user of the in-store navigation computer system, wherein the shopping list includes at least one product available for purchase at a merchant location. The method also includes receiving product location information for the merchant location, generating a shopping route for the user at the merchant location based on the shopping list and the product location information, providing the shopping route as a navigation display to a mobile device of the user, receiving location information from the mobile device, and updating the navigation display on the mobile device based on the location information received from the mobile device.

### CROSS-REFERENCE TO RELATED APPLICATIONS

This application claims priority to U.S. Provisional Patent Application Ser. No. 62/195,102, entitled “Systems and Methods for Providing Customized In-Store Navigation,” filed on Jul. 21, 2015, which is incorporated herein by reference in its entirety and for all purposes.

### BACKGROUND

A patron at a merchant location (i.e., a customer) is sometimes provided with tools that are intended to enhance the shopping experience of the customer. For instance, the customer may be provided with a store layout or other navigation tools intended to help the customer to locate desired products, stores, departments, restrooms, customer service, and the like within the merchant location. However, such tools are typically provided by the merchant or another party that is not affiliated with the customer. Thus, these tools may only allow for limited customization, and may not be tailored to meet the particular needs of the customer. As an example, navigation tools (e.g., a store map) may be unable to assist with customer decision-making or provide targeted recommendations and offers to the customer. Further, any customization that may be available is typically reliant on the customer to manually enter any customer-specific information and independently determine the customer's own preferences.

### SUMMARY

One embodiment of the present disclosure relates to a computer-implemented method performed by one or more processors of an in-store navigation computer system. The method includes receiving, by the in-store navigation computer system, a shopping list from a user of the in-store navigation computer system, wherein the shopping list includes at least one product available for purchase at a merchant location, receiving, by the in-store navigation computer system, product location information for the merchant location, and generating, by the in-store navigation computer system, a shopping route for the user at the merchant location based on the shopping list and the product location information. The method also includes providing, by the in-store navigation computer system, the shopping route as a navigation display to a mobile device of the user, receiving, by the in-store navigation computer system, location information from the mobile device, and updating, by the in-store navigation computer system, the navigation display on the mobile device based on the location information received from the mobile device.

Another embodiment of the present disclosure relates to a computer-implemented method performed by one or more processors of an in-store navigation computer system. The method includes receiving, by the in-store navigation computer system, a shopping list from a user having one or more financial accounts provided by a financial institution computer system, wherein the shopping list includes a plurality of products available for purchase at a merchant location, receiving, by the in-store navigation computer system, transaction data related to the one or more financial accounts from the financial institution computer system, and determining, by the in-store navigation computer system, a recommended product based on the shopping list and the transaction data. The method also includes generating, by the in-store navigation computer system, a customized shopping list by adding the recommended product to the shopping list received from the mobile device of the user, receiving, by the in-store navigation computer system, product location information for the merchant location, and generating, by the in-store navigation computer system, a shopping route for the user at the merchant location based on the customized shopping list and the product location information.

Another embodiment of the present disclosure relates to a computer-implemented method performed by one or more processors of an in-store navigation computer system. The method includes receiving, by the in-store navigation computer system, a shopping list from a user having an account with the in-store navigation computer system, wherein the shopping list includes a plurality of products available for purchase at a merchant location, receiving, by the in-store navigation computer system, a user preference from the user, and determining, by the in-store navigation computer system, a product to be substituted for one or more of the plurality of products listed on the shopping list based on the user preference, wherein the substitute product is available for purchase at the merchant location and provides a benefit to the user that is related to the user preference. The method also includes generating, by the in-store navigation computer system, a customized shopping list by substituting the substitute product for the one or more products listed on the shopping list, receiving, by the in-store navigation computer system, product location information for the merchant location, and generating, by the in-store navigation computer system, a shopping route for the user at the merchant location based on the customized shopping list and the product location information.

Another embodiment of the present disclosure relates to a computer-implemented method performed by one or more processors of an in-store navigation computer system. The method includes receiving, by the in-store navigation computer system, a shopping list from a user having one or more financial accounts provided by the financial institution computer system, wherein the shopping list includes a plurality of products available for purchase at a merchant location, receiving, by the in-store navigation computer system, product location information for the merchant location, wherein the product location information includes an in-store location for each of the plurality of products listed on the shopping list, and generating, by the in-store navigation computer system, a first shopping route for the user based on the shopping list and the product location information. The method also includes determining, by the in-store navigation computer system, a user rewards offer based on the first shopping route, wherein the user rewards offer includes an offer to provide a reward to the user in exchange for a requested user action, generating, by the in-store navigation computer system, a second shopping route for the user based on the first shopping route and the requested user action, and providing, by the in-store navigation computer system, the first and second shopping routes to a mobile device of the user as selectable options, including providing an indication of the available reward and the requested user action.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a schematic diagram of an in-store customer navigation system, according to an example embodiment.

FIG. 2 is a schematic flow diagram of an in-store customer navigation process that may be implemented using the system shown in FIG. 1, according to an example embodiment.

FIG. 3 is a user interface that may be presented on a display of the mobile device shown in FIG. 1 to enable a user to create a user shopping list, according to an example embodiment.

FIG. 4 is a user interface that may be presented on the display of the mobile device shown in FIG. 1 to enable the user to select a merchant, according to an example embodiment.

FIG. 5 is a schematic flow diagram of a shopping list customization and in-store navigation process that may be implemented using the system shown in FIG. 1, according to an example embodiment.

FIG. 6 is a schematic flow diagram of a rewards-based in-store navigation process that may be implemented using the system shown in FIG. 1, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

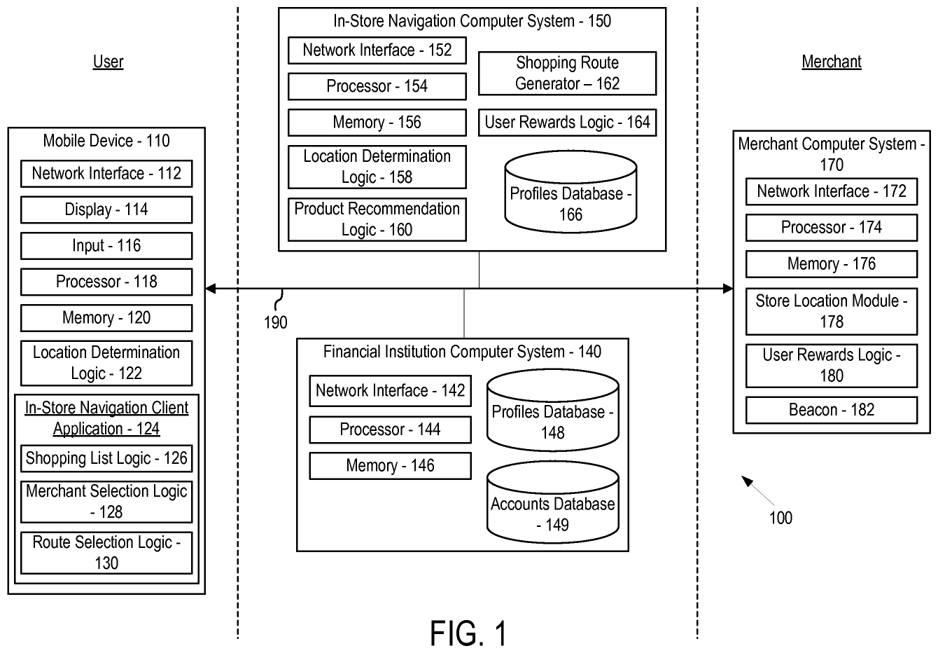

Referring to FIG. 1, an in-store navigation system 100 is shown, according to an example embodiment. The in-store navigation system 100 may be used to navigate a user (i.e., a customer, shopper, account holder, etc.) throughout a merchant location (i.e., a brick and mortar store) in order to complete a shopping list. A user shopping list and a merchant location are provided to a financial institution that provides a financial account to the user. The shopping list may be customized based on financial data of the user (e.g., related to the financial account), user preferences, and information related to the merchant. For instance, the user may receive recommendations to add, substitute, or remove a product from the shopping list based on past transactions and/or one or more preferences provided by the user. The user is provided with customized in-store navigation at a mobile device of the user based on the shopping list and a current layout of the merchant location. The user is also provided with real-time shopping route updates based on the items remaining on the shopping list and a current location of the user mobile device.

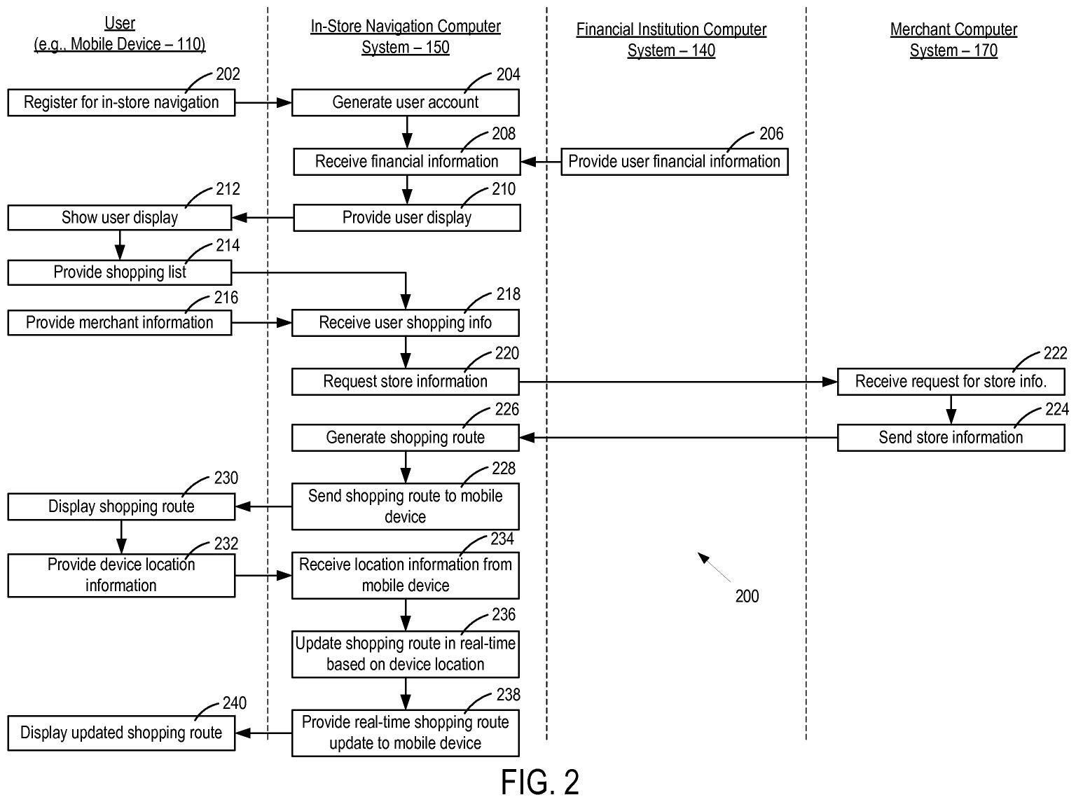

The in-store navigation system 100 may include, among other systems, a mobile device 110, a financial institution computer system 140, an in-store navigation computer system 150, and a merchant computer system 170. The systems may each be owned and operated by a separate entity. Two or more systems may also be combined to operate as a single system, or two or more systems may be owned or operated by a single entity. For instance, the in-store navigation computer system 150 may be operated by either of the financial institution computer system 140 or the merchant computer system 170. The systems may include a computer system (e.g., one or more servers each with one or more processing circuits) configured to execute instructions, send and receive data stored in memory, and perform other operations to implement the operations described herein or associated with logic or processes shown in FIGS. 2 through 7.

The mobile device 110, the financial institution computer system 140, the in-store navigation computer system 150, and the merchant computer system 170 may each include a processor and memory. The processors may be implemented as application specific integrated circuits (ASICs), one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and non-transitory computer storage media. The memory may include data base components, object code components, script components, or any other type of information structure for supporting the various activities and information structures described herein. The memory may be communicably connected to the processor and include computer code or instructions for executing one or more processes described herein.

The mobile device 110, the financial institution computer system 140, the in-store navigation computer system 150, and the merchant computer system 170 may communicate through a network 190. The network 190 may be a single communication network configured to communicatively connect each of the systems, or the network 190 may include a plurality of networks each connecting two or more systems. The network 190 may be a wired or wireless network, including one or more of the Internet, a cellular network, Wi-Fi, Wi-Max, a proprietary banking network, and so on.

The mobile device 110 may be used by an individual user (e.g., a consumer) to access the network 190 and communicate with the other computer systems shown in FIG. 1. The mobile device 110 may be, for example, a cellular phone, smart phone, mobile handheld wireless e-mail device, personal digital assistant, portable gaming device, tablet, laptop, or other suitable device configured to access the network 190. The mobile device 110 may also include a user device or interactive screen that is located on a shopping cart or other device within a merchant location. In an example embodiment, the user of the mobile device 110 is an account holder having one or more financial accounts provided by the financial institution computer system 140.

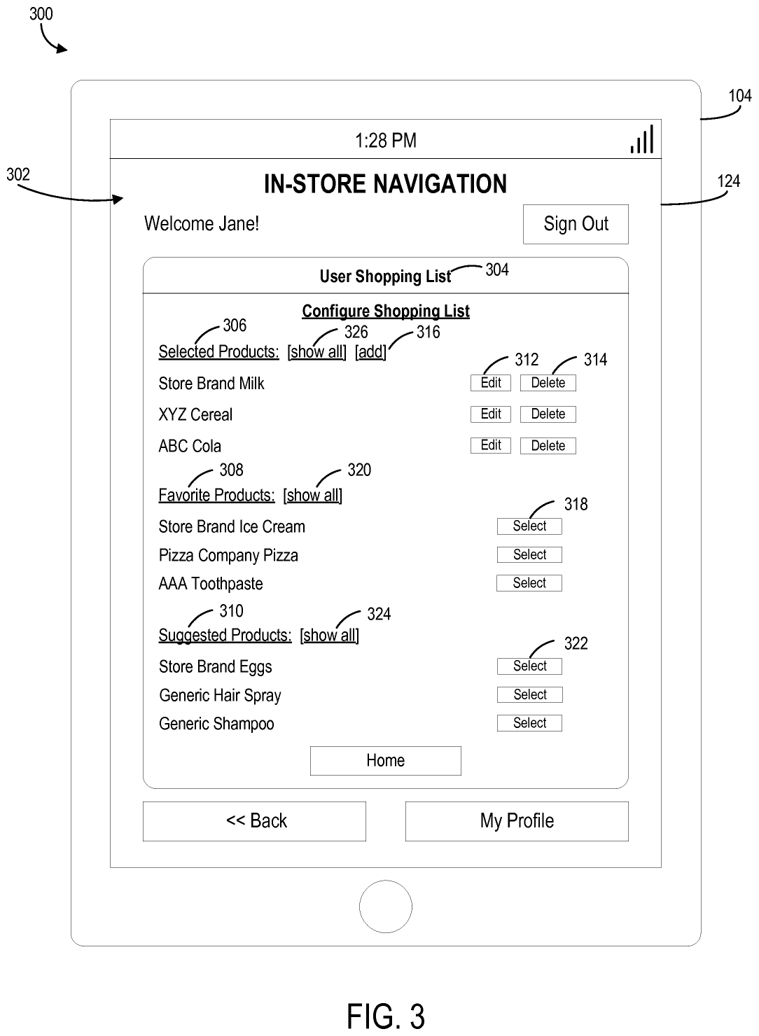

The mobile device 110 includes a network interface 112, a display 114, and an input 116. The network interface 112 may be a wireless network interface that communicates with a wireless communication protocol (e.g., 802.11a/b/g/n, Bluetooth®, ZigBee®, CDMA, GSM, LTE, WiMax, etc.). The network interface 112 may include, for example, program logic that connects the mobile device 110 to the network 190. As described in greater detail below, the mobile device 110 may receive and display screens including a shopping list, product suggestions or substitutions, user rewards offers, shopping route options, an in-store navigation display, and so on. Such screens may be used to prompt the user to provide information regarding a shopping trip, including desired shopping items (e.g., products), a selected merchant or merchant location, a selected in-store shopping route, user rewards, and other information that may be used by the in-store navigation computer system 150 to generate and provide in-store navigation. Such screens are presented to the user via the display 114. Examples of such screens are shown in FIGS. 3 through 5. The input 116 may be used to permit the user to initiate account access and to facilitate receiving requested information from the user. In some arrangements, the display 114 and input 116 are integrated in a touchscreen display. As will be appreciated, in addition to or instead of the mobile device 110, users may also be provided with the ability to access the in-store navigation system 100 using another type of computer (e.g., a desktop or laptop computer executing browser software) to perform the operations described herein as being performed by the mobile device 110. For example, a user may be permitted to populate a shopping list or provide user preferences using another type of computer, then receive customized in-store navigation via the mobile device 110.

The mobile device 110 also includes a processor 118 and memory 120. The memory 120 includes programming modules and logic that, when executed by the processor 118, control the operation of the mobile device 110. For instance, the mobile device 110 also includes location determination logic 122, which may be stored on memory 120. The location determination logic 122 may be executed to determine a location of the mobile device 110. The location of the mobile device 110 may be used by the in-store navigation computer system 150 to navigate a user through a merchant location. A user may opt-in to using the location determination logic 122 to receive in-store navigation updates and alerts, as is described in further detail below. In various embodiments, the location determination logic 122 utilizes a satellite (GPS) sensor at the mobile device 110, or signals that are received at the mobile device 110 from nearby cellular towers to determine the location coordinates of the mobile device 110. The location determination logic 122 may also utilize signals received from locator beacons (e.g., beacon 182) to determine the location of the mobile device 110, as is described below in further detail.

The mobile device 110 also includes an in-store navigation client application 124. The in-store navigation client application 124 can refer to any application or web interface provided to the user via the in-store navigation computer system 150, which may include an application or web interface provided by the financial institution computer system 140 or the merchant computer system 170. The in-store navigation client application 124 enables the user to communicate with the in-store navigation computer system 150. For instance, the user may provide user and shopping-related information to the in-store navigation computer system 150 (e.g., the merchant, the financial institution, etc.) using the in-store navigation client application 124. The in-store navigation client application 124 also displays an in-store navigation window for use within the merchant location. The in-store navigation client application 124 may comprise program logic executable by the mobile device 110 to implement at least some of the functions described herein. The in-store navigation client application 124, including any of the logic described herein, may be stored on memory 120. As will be appreciated, the level of functionality that resides on the mobile device 110 as opposed to the in-store navigation computer system 150 may vary depending on the implementation.

In some embodiments, the in-store navigation client application 124 is provided by a financial institution of the user (i.e., financial institution computer system 140). In these embodiments, at least a portion of the in-store navigation computer system 150 may be stored on the financial institution computer system 140 and/or operated by the financial institution of the user. For example, the in-store navigation client application 124 may be included as part of a mobile banking or mobile wallet application provided by the financial institution computer system 140. In one embodiment, for instance, the client application 124 may be a mobile banking application configured to allow the user to securely access an online banking website of the financial institution and interact with various accounts held by the user. In this embodiment, the in-store navigation computer system 150 described herein is utilized by accessing an in-store navigation area of the mobile banking site or application. The mobile banking application may also enable the user to perform various other tasks or functions that could otherwise be performed using the financial institution website or at a branch location.

In another embodiment, the client application 124 may be a mobile wallet application configured to allow the user to make payments from accounts provided by the financial institution computer system 140 using the mobile device 110. In this embodiment, the user is able to interact with the in-store navigation computer system 150 as described herein by accessing an in-store navigation section of the mobile wallet application. Further, once the user has completed the shopping trip, the user may make a payment using a payment account managed by the financial institution computer system 140 via the mobile device 110. For instance, the mobile wallet application may generate a payment code that may be scanned or otherwise provided at a merchant point of sale to initiate a payment using a payment account held by the user.

In some embodiments, the in-store navigation client application 124 may be provided by a merchant (e.g., the merchant computer system 170). In these embodiments, at least a portion of the in-store navigation computer system 150 may be stored on the merchant computer system 170 and/or operated by the merchant. For instance, the in-store navigation client application 124 may be a merchant-specific application provided by the merchant to assist the user when shopping at a merchant location. In this embodiment, the merchant computer system 170 communicates with the user via the in-store navigation client application 124 to receive various information from the user and display in-store navigation information to the user. The merchant computer system 170 may also communicate with the financial institution computer system 140 to receive transaction information and other information related to the user. The merchant computer system 170 utilizes the information received from the user and the financial institution computer system 140 to perform various functions of the in-store navigation computer system 150, including determining a location of the user, customizing a user shopping list, determining a shopping route at the merchant location, and providing in-store navigation to the user. In other embodiments, the in-store navigation client application 124 may simply refer to a web browser that is configured to receive and display mobile web pages received from the in-store navigation computer system 150 (e.g., web pages prompting the user to provide a shopping list and merchant information, web pages displaying in-store navigation information, etc.).

In the illustrated embodiment of FIG. 1, the in-store navigation client application 124 includes shopping list logic 126, merchant selection logic 128, and route selection logic 130, which may be executed to perform various functions of the in-store navigation client application 124. The shopping list logic 126 allows a user to generate a shopping list by entering names of products that the user intends to purchase at the merchant location. The user of the mobile device 110 may, for instance, select items from a list (e.g., previously purchased, favorites, most popular, etc.), or search for a particular item (e.g., via the internet or a product database) using the in-store navigation client application 124. The in-store navigation computer system 150 may also recommend additional or substitute products to the user via the in-store navigation client application 124. The merchant selection logic 128 enables the user to select a merchant or a specific merchant location for a particular shopping trip. Similar to selecting the products to be purchased, the user may select the merchant from a list or search for a particular merchant. The route selection logic 130 allows the user to select a shopping route for completing the shopping list via the in-store navigation client application 124.

Referring still to FIG. 1, the financial institution computer system 140 is operated by a financial institution providing one or more financial accounts to the user. The financial institution may be or include an issuer, an acquirer, a payment service provider, or any other financial institution configured to manage a user financial account. The one or more financial accounts may be issued by the financial institution computer system 140, as well as provided by another (source) financial institution and managed by the financial institution computer system 140. The financial institution computer system 140 includes a network interface 142 that allows the financial institution computer system 140 to communicate data to and from the other devices and systems described herein (e.g., the mobile device 110, the in-store navigation computer system 150, the merchant computer system 170, etc.) via the network 190. The network interface 142 may include, for example, program logic that connects the financial institution computer system 140 to the network 190. The financial institution computer system 140 also includes a processor 144 and memory 146. In some arrangements, the financial institution computer system 140 includes a plurality of processors. The memory 146 stores programming modules that, when executed by the processor 144, control the operation of the financial institution computer system 140. Such logic may be implemented in a machine (e.g., one or more networked computer servers) comprising machine-readable media (e.g., memory 146) having instructions stored therein which are executed by the machine to perform the operations described herein.

The financial institution computer system 140 includes an accounts database 149 configured to store information (i.e., user financial data) that is related to any of the one or more financial accounts. The user financial data may include account balances, transaction data, and the like. The financial institution computer system 140 may also maintain a profile for each user that includes user preferences or other (e.g., non-transactional) information related to the user or the one or more financial accounts. The user profile may include personal financial management information (e.g., payment preferences, budget goals, savings goals, etc.) that is provided by the user or determined by the financial institution computer system 140. The information may be updated in real-time based on user transactions and other related input received by the financial institution computer system 140. The user profiles are stored in profiles database 148. The data stored within the accounts database 149 and the profiles database 148 may be communicated to and utilized by the in-store navigation computer system 150 to customize the user shopping list and any in-store navigation information that is provided to the user.

The in-store navigation computer system 150 is configured to provide a customized shopping experience for the user of the mobile device 110. In various embodiments, the in-store navigation computer system 150 is configured to customize the shopping list of the user by making recommendations to the user (e.g., adding products, removing products, suggesting substitutions, etc.) based on financial data and preferences of the user. The in-store navigation computer system 150 is also configured to provide in-store navigation at a merchant location based on at least the location of the mobile device 110 and the customized shopping list. The in-store navigation computer system 150 includes a network interface 152 that allows the in-store navigation computer system 150 to communicate data to and from the other devices and systems described herein (e.g., the mobile device 110, the financial institution computer system 140, the merchant computer system 170, etc.) via the network 190. The network interface 152 may include, for example, program logic that connects the in-store navigation computer system 150 to the network 190.

The in-store navigation computer system 150 also includes a processor 154 and memory 156. The memory 156 stores programming modules that, when executed by the processor 154, control the operation of the in-store navigation computer system 150. For instance, the in-store navigation computer system 150 includes location determination logic 158, product recommendation logic 160, shopping route generator 162, and user rewards logic 164. Such logic may be implemented in a machine (e.g., one or more networked computer servers) comprising machine-readable media (e.g., memory 156) having instructions stored therein which are executed by the machine to perform the operations described herein. For instance, such logic may be implemented and executed to customize a user shopping list, as well as to provide in-store navigation at a merchant location to a user of the mobile device 110.

The location determination logic 158 may be executed to determine a location of the mobile device 110. The location determination logic 158 may determine location coordinates of the mobile device 110 or a location of the mobile device 110 relative to a merchant location. The location determination logic 158 may also be configured to track the location of the mobile device 110 in real-time. The location may be determined based on information received from the mobile device 110, such as satellite (GPS) or cellular information.

The location determination logic 158 may also utilize information received from a locator beacon (e.g., beacon 182) to determine the location of the mobile device 110. In an example embodiment, various locating beacons are positioned throughout the merchant location. The locating beacons are configured to broadcast beacon identifiers that can be detected by the mobile device 110 within a predetermined range of the beacon. Each of the beacon identifiers may be matched to a particular location within the merchant location based on a beacon map (e.g., table, chart, etc.) maintained by the merchant (or the operator of the beacons). In this embodiment, the location determination logic 158 is configured to determine the location of the mobile device 110 (and thus the user or account holder) within the merchant location based on receipt of the beacon identifier at the mobile device 110. For instance, the in-store navigation computer system 150 may receive the beacon identifier from the mobile device 110 and determine the approximate location of the mobile device 110 when the beacon identifier was received by consulting the beacon map. The beacon map may be received by the in-store navigation computer system 150 from the merchant computer system 170, or the in-store navigation computer system 150 may request location information from the merchant computer system 170 based on the received beacon identifier. The beacon information may also be used by the location determination logic 158 to supplement GPS or cellular information received from the mobile device 110.

The product recommendation logic 160 may be executed to recommend additional or substitute (i.e., alternative) products to the user. The recommended products are determined based on information related to the user, which may include user financial information (e.g., transaction data, account balances, etc.) as well as user preferences (e.g., brand preferences, product preferences, user goals, etc.). The user information may be received (e.g., by the in-store navigation computer system 150) from the user, the financial institution computer system 140 and/or the merchant computer system 170.

In an example embodiment, the products are recommended to the user based on user transaction data. The user transaction data may include any data associated with a financial transaction, including a timestamp (e.g., date, time, etc.), a payment amount, identification of a user financial account used to execute the transaction, and identification of any other parties to the transaction (e.g., merchants). The user transaction data may be received from the financial institution computer system 140, or from another financial institution that provides a financial account to the user. The user transaction data received from the financial institution computer system 140 may include product-specific information (i.e., an account of any products or services that were purchased within a single transaction). In other embodiments, the user transaction data may be supplemented to include product-specific information. For instance, the merchant computer system 170 may provide an account of any products or services that are purchased by the user within a specific transaction. The product-specific information may be provided based on other details related to the transaction. In other embodiments, the user may supplement the user transaction data with product-specific information and other information in order to receive better targeted offers and benefits from the in-store navigation computer system 150.

In an example embodiment, the product recommendation logic 160 may recommend a product that is typically purchased at regular intervals, such as a perishable food item (e.g., milk, eggs, etc.), based on the past transactions of the user. For instance, the product recommendation logic 160 may recommend purchasing a perishable food item that is available for purchase at the merchant location if the perishable food item has not been purchased by the user within ‘X’ number of days or weeks (according to user transaction data received by the in-store navigation computer system 150). The designated time period ‘X’ may be determined based on a typical expiration period or consumption (e.g., exhaustion) cycle of the perishable food item. As another example, the product recommendation logic 160 may recommend a product or item that is typically purchased at another merchant or merchant location, or a substitute product that is substantially similar to the previously purchased product. For instance, if the user typically purchases a delivery pizza on Saturday evenings, the product recommendation logic 160 may recommend a deli pizza for purchase at the merchant location when in close proximity to Saturday evening.

The product recommendation logic 160 may also be executed to recommend substitute (i.e., alternative) products to the user in place of products that the user has listed on the user shopping list. The substitute products may be recommended based on the user profile, including any user preferences described herein, as well as financial data of the user. As an example, the product recommendation logic 160 may recommend a substitute product based on a budget constraint (i.e., budget preferences) provided by the user. For instance, the user may provide a monthly budget limit for food purchases. As a result, the product recommendation logic 160 may recommend lower-priced (e.g., generic) versions of a listed item in order to save money and meet the specified budget constraint. The user budgets may be continuously monitored by the in-store navigation computer system 150 based on user transaction data. In some embodiments, the product recommendation logic 160 recommends substitute products only when the user spending is at or near the budget constraint, which may be determined based on the user transaction data. The product recommendation logic 160 may automatically update the shopping list to include the substitute products. The user may also have the option to approve, cancel, or edit any product substitutions.

The shopping route generator 162 may be executed to generate one or more in-store shopping routes for the user based on the user shopping list and details of the merchant location. The generated shopping routes are intended to route the user throughout the merchant location to each of the products on the user shopping list. In an example embodiment, the shopping route generator 162 is configured to generate the most efficient (i.e., fastest) route through the merchant location that includes each product on the user shopping list. However, the one or more shopping routes may also be generated based on other factors. For instance, the user may select (e.g., via the in-store navigation client application 124) one or more factors upon which the generated shopping route is based. For example, a shopping route may be generated to minimize the distance traveled by the user, to adjust (e.g., maximize, minimize) the time spent within a particular area of the merchant location, or to maximize the user rewards generated during the shopping trip. When two or more shopping routes are generated by the shopping route generator 162, the route options may be presented to the user for selection (e.g., via the mobile device 110).

The shopping routes may also be generated by the shopping route generator 162 to include additional locations (other than the product locations) based on input received from the user (e.g., via the in-store navigation client application 124), the financial institution computer system 140, and/or the merchant computer system 170. For instance, the shopping route may be generated to include a restroom, a customer service location, and/or another designated area of the merchant location based on a selection of one or more of these locations received from the user. The shopping route may also be generated to include stores or departments (within the merchant location) that are preferred by the user but are not otherwise required based on the user shopping list. Preferred stores or departments may be determined by the in-store navigation computer system 150 (e.g., the shopping route generator 162) based on user transaction data and/or user preferences.

In some embodiments, the generated shopping routes include one or more incentives (i.e., user rewards) that are available to the user for completing an action associated with the shopping route. For instance, a shopping route may include additional “sponsored,” or otherwise designated, products that are added to the user shopping list, and thus the generated shopping route. When this shopping route is selected, the user may receive a user reward for traveling to the location of the sponsored product and/or purchasing the sponsored product. As another example, a shopping route may be generated to include a designated area (e.g., store, department, etc.) of the merchant location that would not otherwise be visited during the user shopping trip. When this shopping route is selected, the user may receive a user reward for traveling to the designated area. The user rewards provided in these embodiments may be funded by the merchant or another entity associated with the sponsored product and/or area. The user rewards are provided to the user via the in-store navigation computer system 150. The user rewards may be any form of value that can be transferred to the user, such as discounts, rewards points, cash back, merchandise, gift cards, and the like. In some embodiments, the shopping route is generated by the shopping route generator 162 based on the available user rewards, such as to maximize the user rewards that can be earned by the user in a single shopping trip or earn the most of a specific (e.g., user-specified) type of reward.

The user rewards logic 164 may be executed to determine the user rewards that are available to the user during a particular shopping trip. For instance, the user rewards may be provided for purchasing products that are listed on the user shopping list, for completing the user shopping list (i.e., purchasing all products on the list), or for purchasing additional or substitute products that are recommended by the in-store navigation computer system 150. The user rewards logic 164 may also be configured to provide rewards to the user for following a designated in-store path (i.e., a shopping route) that is provided by the in-store navigation computer system 150. For instance, the user may receive additional rewards for selecting and following an in-store path causing the user to pass by the designated product or area within the merchant location. In this example, the reward may be received from the merchant and/or the provider of the designated product and provided to the user by the in-store navigation computer system 150. The user rewards logic 164 may determine the available user rewards based on information received from any of the other entities of the system 100. For instance, offers for user rewards that are intended for the user may be received by the in-store navigation computer system 150 from the merchant computer system 170 and/or the financial institution computer system 140. The in-store navigation computer system 150 may also receive user rewards offers from other entities (e.g., entities associated with a designated product or service) via the merchant computer system 170 or the financial institution computer system 140.

The merchant computer system 170 includes a network interface 172 that allows the merchant computer system 170 to communicate data to and from the other devices and systems described herein (e.g., mobile device 110, financial institution computer system 140, etc.) via the network 190. The network interface 172 may include, for example, program logic that connects the merchant computer system 170 to the network 190. The merchant computer system 170 also includes a processor 174 and memory 176. In some arrangements, the merchant computer system 170 includes a plurality of processors. The memory 176 stores programming modules that, when executed by the processor 174, control the operation of the merchant computer system 170. For instance, the merchant computer system 170 includes a store location module 178 and user rewards logic 180. Such logic may be implemented in a machine (e.g., one or more networked computer servers) comprising machine-readable media (e.g., memory 176) having instructions stored therein which are executed by the machine to perform the operations described herein. For instance, the store location module 178 may be implemented and executed to provide merchant location information to the in-store navigation computer system 150. The location information may include a location of a merchant location associated with the merchant computer system 170. The user rewards logic 180 may be executed to generate various user rewards intended to be earned by the user. The user rewards may be generated based on information related to the user and the financial institution computer system 140. The various user rewards are described in further detail below.

Referring to FIGS. 2, 5, and 6, processes 200, 500, and 600 are shown for providing in-store navigation within a merchant location to a user of the in-store navigation system 100. The process 200 may be performed using the in-store navigation system 100 shown in FIG. 1. In particular, the process 200 may be performed using any or all of the mobile device 110, the financial institution computer system 140, the in-store navigation computer system 150, and the merchant computer system 170, including any logic or other components of the systems and devices that are described in further detail herein. In some embodiments, the steps of processes 200, 500, and 600 that are shown and described as being performed by the in-store navigation computer system 150 may be performed by the merchant computer system 170 and/or the financial institution computer system 140. For instance, one or more components of the in-store navigation computer system 150 may be stored and operated by the systems 140 and/or 170 to perform the operations attributed to the in-store navigation computer system 150 in processes 200, 500, and 600.

Referring particularly to FIG. 2, process 200 is shown for providing in-store navigation at a merchant location, according to an example embodiment. The process 200 may include receiving a shopping list from a user, providing one or more shopping routes to the user based on the shopping list and the merchant location, and providing real-time customized in-store navigation to the user (e.g., at the mobile device 110) based on the location of the user (e.g., the mobile device 110) and user inputs.

At 202 of the process 200, the user registers with the in-store navigation system 100 (e.g., the in-store navigation computer system 150) by providing information to the in-store navigation computer system 150. The information may include identifying information for the user, various user preferences, as well as identification of one or more user financial accounts (and associated financial institution(s)). At 204, the in-store navigation computer system 150 generates an account for the user based on the information received. The account may be stored in the database 166. The user account may be used to store any information related to the user and received or determined as part of the in-store navigation system 100. For instance, the user account may include details related to the user's financial accounts, including transaction data, account balances, and identifying information for the associated financial institution(s). The user account may also include details related to past shopping trips of the user, including a listing of any products that were added to a user shopping list or purchased while using the in-store navigation system 100. The user account may also include any user preferences described herein, such as preferred merchants, products, or user rewards.

At 206, the financial institution computer system 140 provides user financial information to the in-store navigation computer system 150. The user financial information may include transaction data related to any financial accounts held by the user and provided by the financial institution computer system 140. The financial institution computer system 140 may refer to more than one financial institution, and may include any financial institutions providing a financial account to the user. The user may provide a listing of any financial accounts held by the user and authorize the financial institution computer system 140 to provide financial information, including transaction data, to the in-store navigation computer system 150. At 208, the financial information is received from the financial institution computer system 140.

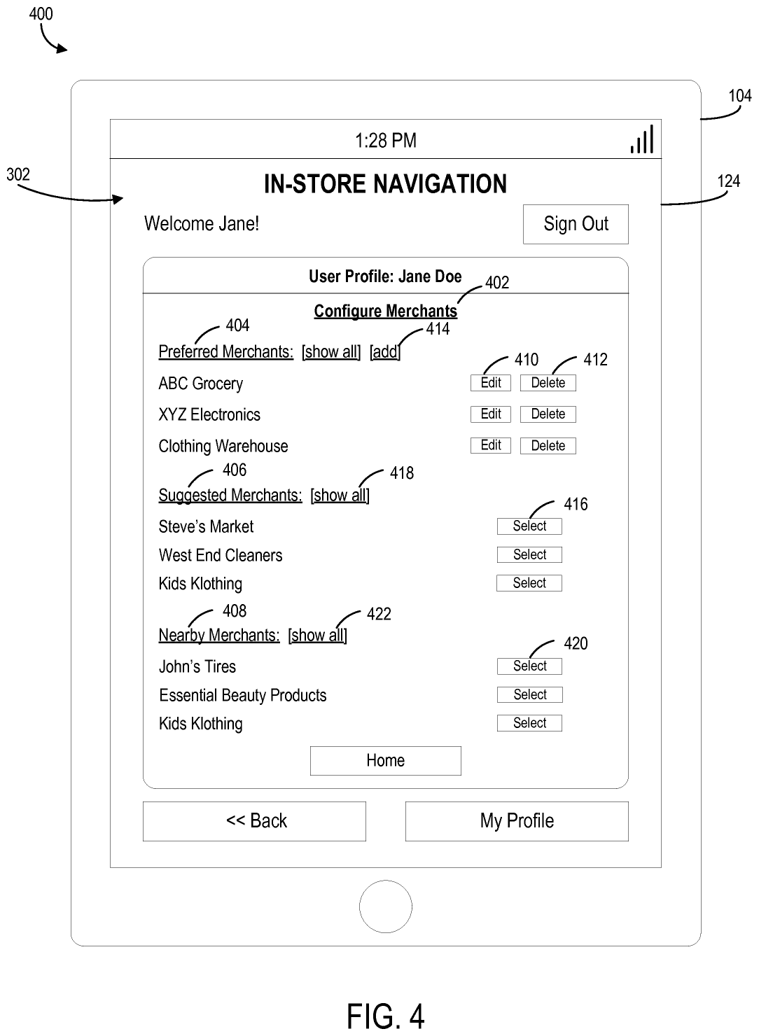

At 210, the in-store navigation computer system 150 generates a user display and provides the display to the user. Examples of the user display are shown in FIGS. 3 and 4. The user display may be utilized by the in-store navigation computer system 150 to communicate any information to the user, including any product recommendations and navigation information. The user display may be provided using the in-store navigation client application 124 stored on the mobile device 110. At 212, the user display is received by the user and may be displayed on the mobile device 110 (or another user device).

At 214, the user provides a user shopping list to the in-store navigation computer system 150. The user may provide the shopping list, and any other information, using the mobile device 110. The user shopping list includes products that the user wishes to purchase on a particular shopping trip. The products may be selected based on suggestions provided by the in-store navigation computer system 150. For instance, the in-store navigation computer system 150 may automatically populate an initial shopping list (e.g., suggest one or more products) based on a user profile, including the user's transaction data. The products may also be selected based on a product inventory received from the merchant computer system 170. The user may then edit, remove, and add products to the shopping list. The products may also be selected by manual input of the user.

For example, FIG. 3 shows a user interface 300 (i.e., user display) that may be presented to the user on the display 114 of the mobile device 110 when the user is accessing the in-store navigation client application 124. As shown on the user interface 300, the user can log into the website 302 and access a user shopping list at area 304. The user shopping list area 304 includes a display of selected products 306, which includes any products currently listed on the shopping list. The selected products 306 may have been chosen by the user or automatically added by the in-store navigation computer system 150 based on user preferences. The user shopping list area 304 also includes a display of favorite products 308 and suggested products 310, as determined by the in-store navigation computer system 150. The user can edit or delete a selected product by interacting with buttons 312 and 314, respectively. The user can also add a product to the user shopping list by interacting with link 316. For instance, the user may be able to search for products based on the brand name, the generic name of the product, a product category, an associated merchant, or based on any other information provided herein. The search may be performed via the Internet or from a product database maintained as part of the in-store navigation system 100. The user may see all of the selected products in the user shopping list by interacting with link 326.

The user can also select one of the “favorite” products to be added to the user shopping list by interacting with an associated button 318. The favorite products may be determined based on past transactions of the user, or based on selections by other users of the in-store navigation system 100. The user may see all of the favorite products by interacting with link 320. The user can select one of the suggested products by interacting with an associated button 322. The suggested products may be determined (e.g., by the in-store navigation computer system 150) based on the financial data related to the user and user preferences. The user may see all of the suggested products by interacting with link 324.

At 216, the user provides merchant information to the in-store navigation computer system 150 using the mobile device 110. The merchant information may include selection of a merchant, as well as a particular merchant location, for purchasing the items on the shopping list. In one embodiment, the in-store navigation computer system 150 provides suggestions of merchants and/or merchant locations based on the shopping list provided. For instance, the in-store navigation computer system 150 may receive the user shopping list and select a nearby (e.g., within a predetermined distance of the user, within a specific geographic area, etc.) merchant location having the greatest number of products available from the shopping list, having one or more products available at the lowest cost, having a payment option amenable to the user, etc. The user may then select the merchant location based on the information that is provided. Alternatively, the in-store navigation computer system 150 may select the merchant location based on the user shopping list and any other information provided.

In other embodiments, the merchant location may be selected prior to the in-store navigation computer system 150 receiving the user shopping list. For instance, the in-store navigation computer system 150 may suggest products to be added or substituted to the user shopping list based on the merchant location. As an example, when the in-store navigation computer system 150 is operated by the merchant computer system 170, the merchant may be automatically selected based on the user's interaction with the in-store navigation computer system 150.

FIG. 4 shows another user interface 400 that may be presented to the user on the display 114 of the mobile device 110 when the user is accessing the in-store navigation client application 124. As shown on the user interface 400, the user can access a merchant selection area 402, including a display of selected preferred merchants 404, suggested merchants 406, and nearby merchants 408. The user can edit or delete a preferred merchant by interacting with buttons 410 and 412, respectively. The user can also add a preferred merchant by interacting with link 414. For instance, the user may be able to search for merchants based on proximity to the user. The user may also search for merchants based on the availability of the products listed on the user shopping list at the merchant location. The user may also search for merchants based on the available user rewards at the merchant location.

The user can select one of the suggested merchants to be added to the preferred merchants by interacting with an associated button 416. The suggested merchants may be provided based on user preferences or any other information stored in the user account. For instance, the suggested merchants may be suggested to the user based on user transaction data or other account information. The user may see all of the suggested merchants by interacting with link 418. The user can select one of the nearby merchants to be added to the preferred merchants by interacting with an associated button 420. The nearby merchants may be a listing of the merchants closest to the user (e.g., the mobile device 110) at any time. The user may see all of the nearby merchants by interacting with link 422.

At 218, the in-store navigation computer system 150 receives the user shopping information from the user, which may include the user shopping list and/or the merchant information. The shopping list and the merchant information may be received from the user via the in-store navigation client application 124. Any information received from the user may be stored in the user account (i.e., in the accounts database 166) and/or the user profile (e.g., profiles database 148). The in-store navigation computer system 150 may also receive location information from the mobile device 110. For instance, the location information may include satellite or cellular signals intended to provide location coordinates. The location information may also include beacon identifiers received at the mobile device 110. The beacon identifiers may be correlated with a specific location based on a beacon map, as is described above.

At 220, the in-store navigation computer system 150 identifies the merchant (e.g., the merchant location, the merchant computer system 170, etc.) and requests additional store information from the merchant computer system 170. In one embodiment, the in-store navigation computer system 150 identifies a particular location of the merchant based on a location of the mobile device 110 (or another location of the user). In other embodiments, the merchant location is provided by the user. When the in-store navigation computer system 150 is operated by an entity other than the merchant computer system 170, the in-store navigation computer system 150 may also identify the merchant computer system 170 in order to communicate with the merchant. For instance, the in-store navigation computer system 150 may notify the merchant that the user intends to shop at the merchant location and request offers or rewards based on the shopping trip. The in-store navigation computer system 150 may also request offers or rewards based on specific products included in the shopping list.

The request for store information may include an indication of the user and/or the user shopping list in order to receive targeted store information based on the user and/or the products to be purchased. The request may be a targeted request for specific store information (e.g., a current product inventory, a store layout, a listing of all merchant locations, store hours, etc.). The in-store navigation computer system 150 may also send a general request for all available and relevant information regarding the merchant location. Although the request is shown in FIG. 2 as occurring after the in-store navigation computer system 150 receives the shopping list and other related information from the user, the in-store navigation computer system 150 may request store information at any time as part of the process 200, including prior to receiving any shopping information from the user. In embodiments in which the in-store navigation computer system 150 is operated by the merchant computer system 170, the in-store navigation computer system 150 accesses the additional merchant information at the merchant computer system 170 based on the selected merchant location.

At 222, the merchant computer system 170 receives the request for store information. At 224, the merchant computer system 170 sends store information to the in-store navigation computer system 150 according to the request. The store information may include product information, including a listing of products that are typically available at the merchant location. The store information may also include a current inventory of products provided at the merchant location, including any products that are currently out of stock. For instance, the in-store navigation computer system 150 may request product information for the products listed on the user shopping list, including requesting an indication that the listed products are currently available for purchase. The merchant computer system 170 may then provide information related to the selected products. The store information may also include pricing information for any products, including any available discounts, rebates, or other offers that may be available to the user.

In an example embodiment, the in-store navigation computer system 150 also receives a current store layout for the merchant location. The current store layout may include a building layout of the merchant location, as well as a location within the merchant location of the products that are available for purchase. The current store layout may identify particular departments within a store, or individual stores within a multi-store location. For instance, the in-store navigation computer system 150 may provide the user shopping list with the request, and the current store layout may include location information for each product listed on the user shopping list. The product location information may include exact coordinates of a particular product within the merchant location or a location of the department or section with which the product is included. The current store layout may also include location information for any check-out locations (e.g., cash registers, scanners, etc.), customer service centers, restrooms, shopping cart pick-up and return areas, parking areas, restaurants, or other areas of the store relevant to the user shopping experience. The store information may also include any other information required by the in-store navigation computer system 150 to customize the user shopping list and/or provide in-store navigation to the user at the merchant location, including any other information described herein.

Although the store information is provided in FIG. 2 in response to a request, the required store information may be otherwise received or accessed by the in-store navigation computer system 150 in other embodiments. For instance, merchants (e.g., the merchant computer system 170) may “opt in” to the in-store navigation system 100 in order to encourage users to purchase products from the merchant in exchange for useful store information and/or user rewards provided by the merchant computer system 170. The merchant computer system 170 may then provide store information at regular intervals or based on a triggering event. For instance, the updated store information may be provided upon request, when significant changes occur to the store layout, or when a product is no longer in stock. In an exemplary embodiment, the in-store navigation computer system 150 is configured to access an inventory management system of the merchant computer system 170 in order to receive regular updates related to the inventory of one or more merchant locations.

At 226, the in-store navigation computer system 150 receives the requested store information and generates a shopping route for the user. The shopping route is generated based on the user shopping list and information related to the merchant location. In an example embodiment, the in-store navigation computer system 150 determines the most efficient (e.g., fastest, shortest distance traveled, etc.) shopping route through the merchant location that includes the products location(s) for each product listed on the user shopping list. The shopping route may also be generated based on any other variables or considerations described herein. For instance, the shopping route may be generated to maximize user rewards, minimize a distance traveled by the user, or minimize the cost of the shopping trip. The shopping route may also be generated to ensure a minimum number of steps by the user of the mobile device 110 in order to achieve a user fitness goal. In other embodiments, the shopping route may be generated based on suggested or impulse purchases that are identified by the in-store navigation computer system 150 based on the user profile.

At 228, the in-store navigation computer system 150 sends the shopping route to the user at the mobile device 110 (e.g., via the in-store navigation client application 124). At 230, the shopping route is received and displayed by the user. The user may have the option to accept, reject, or edit the shopping route via the mobile device 110. For instance, the user may request that the in-store navigation computer system 150 re-calculate the shopping route based on additional information. The selected shopping route is displayed to the user by the mobile device 110 (or another user device). The shopping route may be displayed via the in-store navigation client application 124.

At 232, the mobile device 110 provides device location information to the in-store navigation computer system 150. For instance, device location information may be provided continuously to the in-store navigation computer system 150 based on movement of the mobile device 110 (i.e., the user) throughout the merchant location. The location information may include a GPS signal that is received from the mobile device 110. The location information may also be based on cellular signals or beacon identifiers received at the mobile device 110. In one embodiment, the product locations (i.e., locations associated with products on the user shopping list) represent checkpoints on the shopping route and updated device location information is sent by the mobile device 110 at each of these checkpoints. At 234, the in-store navigation computer system 150 receives the device location information.

At 236, the in-store navigation computer system 150 updates the shopping route based on the device location information. The shopping route may be updated continuously (e.g., in real-time) as the user travels throughout the merchant location. For instance, the shopping route may include turn-by-turn directions and the directions may be updated based on the current location of the mobile device 110 (i.e., the user). The current destination may also be updated to identify the next product on the user shopping list once the user reaches a checkpoint (i.e., a product location). At 238, the in-store navigation computer system 150 sends an updated shopping route to the mobile device 110 in real-time. At 240, the mobile device 110 displays the updated shopping route to the user. The in-store navigation computer system 150 may continuously update the shopping route and provide the updated shopping route to the mobile device 110 as additional device location information is received. This process may repeat until the shopping list is completed or the user exits the merchant location.

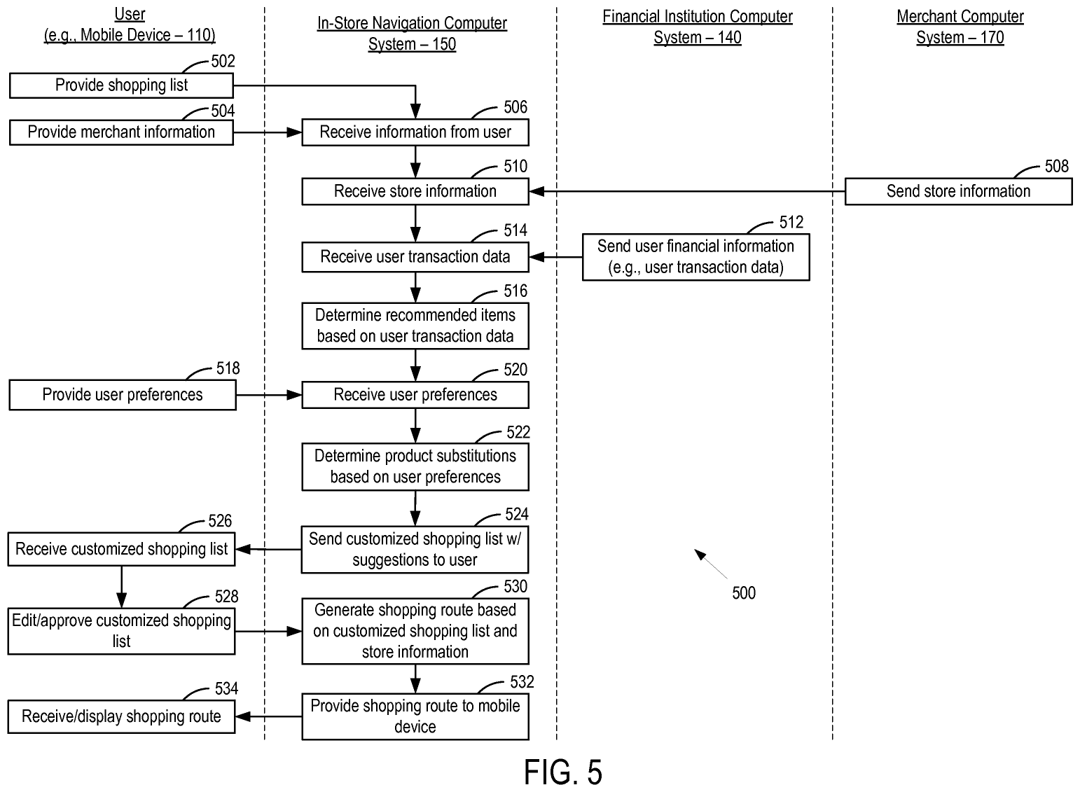

Referring now to FIG. 5, process 500 is shown for providing a customized shopping list and in-store navigation to a user at a merchant location, according to an example embodiment. The process 500 may include customizing a shopping list for a user based on information related to the user and a selected merchant, and generating an in-store shopping route for the user at a merchant location based on the customized user shopping list.

At 502 of the process 500, the user provides a shopping list to the in-store navigation computer system 150 (e.g., using the mobile device 110). The shopping list includes items (i.e., products, services, etc.) that the user intends to purchase. Each product listed may include the name of the product, including a brand name, and a quantity of the product. At 504, the user provides information regarding the merchant, which may include identification of a merchant location. The shopping list and the merchant information may be provided separately (e.g., upon request by the in-store navigation computer system 150), or simultaneously. The user may provide information to the in-store navigation computer system 150 by various methods, including via a website associated with the in-store navigation computer system 150 (e.g., a website of the financial institution or the merchant) or using the in-store navigation client application 124. At 506, the in-store navigation computer system 150 receives the information provided by the user.

At 508, the merchant computer system 170 provides store information to the in-store navigation computer system 150. At 510, the in-store navigation computer system 150 receives the information. The information may be provided upon request or automatically (e.g., at regular intervals, based on a triggering event, continuously, etc.). The store information includes information related to the selected merchant location, including a current store layout and product information. In an example embodiment, the store information includes a current inventory (e.g., actual, expected, estimated, etc.) of all products available for purchase at the merchant location and their location(s) within the merchant location. The product information may also include pricing information for each of the products, including any rewards or offers associated with the products. The products may also be categorized according to a general application or use of the product. For instance, all types and brands of bottled water may be grouped and sorted by brand, price, size, or any other characteristic of the bottled water that is known. The product information may also include expiration dates (e.g., sell-by date, use-by date, etc.) for the product, serving sizes, caloric content and other nutritional facts, and any other information that may be relevant or useful to perform the functions of the in-store navigation computer system 150.

At 512, the financial institution computer system 140 provides user transaction data to the in-store navigation computer system 150. The user transaction data may be related to transactions performed using financial accounts provided or managed by the financial institution computer system 140, or using other accounts held by the user. The user may authorize the financial institution computer system 140 to provide the data (e.g., using the in-store navigation client application 124). The user may authorize use of the data as part of the registration process for the in-store navigation system 100 (e.g., the in-store navigation client application 124). The financial institution computer system 140 may also be authorized to provide the transaction data when the user registers for a financial account with the financial institution computer system 140. In other embodiments, the financial institution computer system 140 may periodically push user transaction data to the in-store navigation computer system 150 using the mobile device 110. At 514, the in-store navigation computer system 150 receives the user transaction data. The user transaction data may be received by the in-store navigation computer system 150 at any time, including prior to the user providing any shopping information. The data may be provided and received continuously, periodically, or based on a triggering event (e.g., a transaction authorized by the user). The in-store navigation computer system 150 may also receive or access user transaction data from the merchant computer system 170. The data received from the merchant computer system 170 may supplement the transaction data from the financial institution computer system 140. For instance, the data received from the merchant computer system 170 (e.g., receipt information, inventor changes, etc.) may be used to determine particular items that were purchased by the user within a particular transaction.

At 516, the in-store navigation computer system 150 determines one or more recommended products for the user shopping list based on the user transaction data. The recommended products may include any products that are not listed on the shopping list provided by the user. The recommended products may also include additional quantities of products that have been listed on the user shopping list. In one embodiment, the recommended products may include products that have been previously purchased by the user. For instance, a product that has been periodically purchased in the past may be recommended based on the amount of time since the product was last purchased by the user. If the amount of time (e.g., number of days) since the product was last purchased by the user (e.g., at the merchant) is greater than a threshold amount of time, then the in-store navigation computer system 150 is configured to recommend that the product be added to the user shopping list. The threshold amount of time may be based on an average time between past purchases of the product, an expiration period associated with the product, an available upgrade for the product, or a quantity and serving size of the product. This information may be determined based on user transaction data received from the financial institution computer system 140, as well as product information received from the merchant computer system 170.

As an example, the in-store navigation computer system 150 may recommend that milk be added to the shopping list if milk has not been purchased by the user within the typical expiration period of milk (e.g., 2 weeks). In this example, the in-store navigation computer system 150 may determine any user transactions with the merchant based on transaction data received from the financial institution computer system 140, then determine milk purchases within those transactions, as well as any characteristics of the milk purchased, based on the product data received from the merchant computer system 170 for those specific transactions. The details of a particular transaction (e.g., products purchased) may also be determined by the in-store navigation computer system 150 based on data received during the shopping trip associated with that transaction. For instance, if the user utilized the in-store navigation client application 124 to communicate with the in-store navigation computer system 150 during the prior shopping trip, the user shopping list and other data may be stored in memory 156 and accessible to the in-store navigation computer system 150 to tailor the current shopping trip for the user.

In another embodiment, the in-store navigation computer system 150 recommends products to the user that are available at the merchant location but that are typically purchased by the user from another merchant or at another merchant location. The in-store navigation computer system 150 may determine that the product is available at the merchant location based on the store information received from the merchant computer system 170. The in-store navigation computer system 150 may recommend the item for purchase in order to save time for the user. The in-store navigation computer system 150 may also recommend the product if the product is available at the merchant location for a price that is less than a price previously paid by the user at another location. As an example, the in-store navigation computer system 150 may recommend that a deli pizza available at the merchant location be added to the user shopping list based on past purchases of delivery pizza. For instance, the in-store navigation computer system 150 may determine that the user typically orders a delivery pizza on most Saturday evenings (i.e., based on user transaction data received from the financial institution computer system 140 and/or the merchant computer system 170) and recommend that the user purchase a deli pizza at the merchant location during a shopping trip occurring just prior to Saturday evening (e.g., within a specified time frame). The in-store navigation computer system 150 may recommend the product in order to save money for the user, such as to meet a budget constraint specified by the user. Along with suggesting the recommended product, the in-store navigation computer system 150 may also convey a value associated with the recommended product, such as the amount of money saved relative to a delivery pizza purchase.

At 518, the user provides various preferences to the in-store navigation computer system 150. At 520, the in-store navigation computer system 150 receives the user preferences, which may be stored in the profiles database 148 of the financial institution computer system 140 and utilized by the financial institution computer system 140 to form a user profile. The user preferences may be similarly stored by the in-store navigation computer system 150 as part of the user account (e.g., in accounts database 166). The user preferences may be provided by the user using the in-store navigation client application 124. The user preferences may be provided at any time by the user, including when the user registers a financial account with the financial institution computer system 140 or registers an account with the in-store navigation computer system 150. The user preferences may be provided upon request (e.g., by a prompt via the in-store navigation client application 124), or the user preferences may be provided manually by the user.

The user preferences are related to the in-store navigation computer system 150 and the various features provided. For instance, the user preferences may include merchant preferences, including preferred merchants, preferred merchant locations, preferred shopping areas, and the like. The user preferences may also include product preferences, such as preferred products, preferred brands, preferred product quantities, preferred nutritional content, preferred sizes (e.g., clothing sizes), and the like. The user preferences may also include financial preferences, including preferred payment methods, specified budget constraints, and financial goals of the user. The user preferences may also include user rewards preferences, including preferred rewards types, preferred rewards accounts, etc.

At 522, the in-store navigation computer system 150 determines substitute products for the user shopping list based on the user preferences. For instance, the in-store navigation computer system 150 may recommend product substitutions when a selected product is non-compliant with one or more user preferences, or when a recommended substitute product would increase the overall satisfaction of the user. As an example, the in-store navigation computer system 150 may determine that purchasing all products on the user shopping list would cause the user to exceed a monthly budget for food purchases (i.e., according to the provided user preferences and the past transactions of the user). The monthly budget is provided by the user. The monthly budget may be provided to the in-store navigation computer system 150 directly from the user or received via the financial institution computer system 140. The in-store navigation computer system 150 may determine the user's status with regard to the monthly budget based on transaction data received from the financial institution computer system 140 and the merchant computer system 170. For instance, the in-store navigation computer system 150 may be configured to determine that a transaction occurred based on transaction data received from the financial institution computer system 140. The in-store navigation computer system 150 may then categorize the products or services within a particular transaction based on information (i.e., product information) received from the financial institution computer system 140 and/or the merchant computer system 170. The in-store navigation computer system 150 may also categorize a particular transaction based on the type of merchant. The in-store navigation computer system 150 may also request that the user categorize any transactions or purchases for which there is insufficient information available. When the user is at or near a particular budget, the in-store navigation computer system 150 may notify the user (i.e., using the client application 124) and recommend one or more product substitutions to reduce the total cost of the products on the user shopping list such that the user remains within the monthly food budget. For instance, the substitute products may be generic (e.g., store brand) versions of the products selected by the user. The in-store navigation computer system 150 may also suggest that one or more products be removed from the user shopping list, or moved to a shopping list for the next month, in order to meet the monthly food budget.

At 524, the in-store navigation computer system 150 sends the customized shopping list to the mobile device 110 (i.e., the user). The customized shopping list may include any additional products or substitute products that are recommended by the in-store navigation computer system 150. At 526, the user receives the customized shopping list at the mobile device 110. At 528, the user edits and/or approves the customized shopping list using the mobile device 110.

At 530, the in-store navigation computer system 150 receives the approval of the user and generates an in-store shopping route for the user based on the customized shopping list and information related to the merchant location. At 532, the in-store navigation computer system 150 provides the in-store shopping route to the mobile device 110. The mobile device 110 may display the in-store shopping route to the user and the in-store navigation computer system 150 may update the in-store shopping route in real-time based on the location of the mobile device 110 within the merchant location. At 534, the shopping route is received by the user and may also be displayed to the user via the mobile device 110 (e.g., via the in-store navigation client application 124).

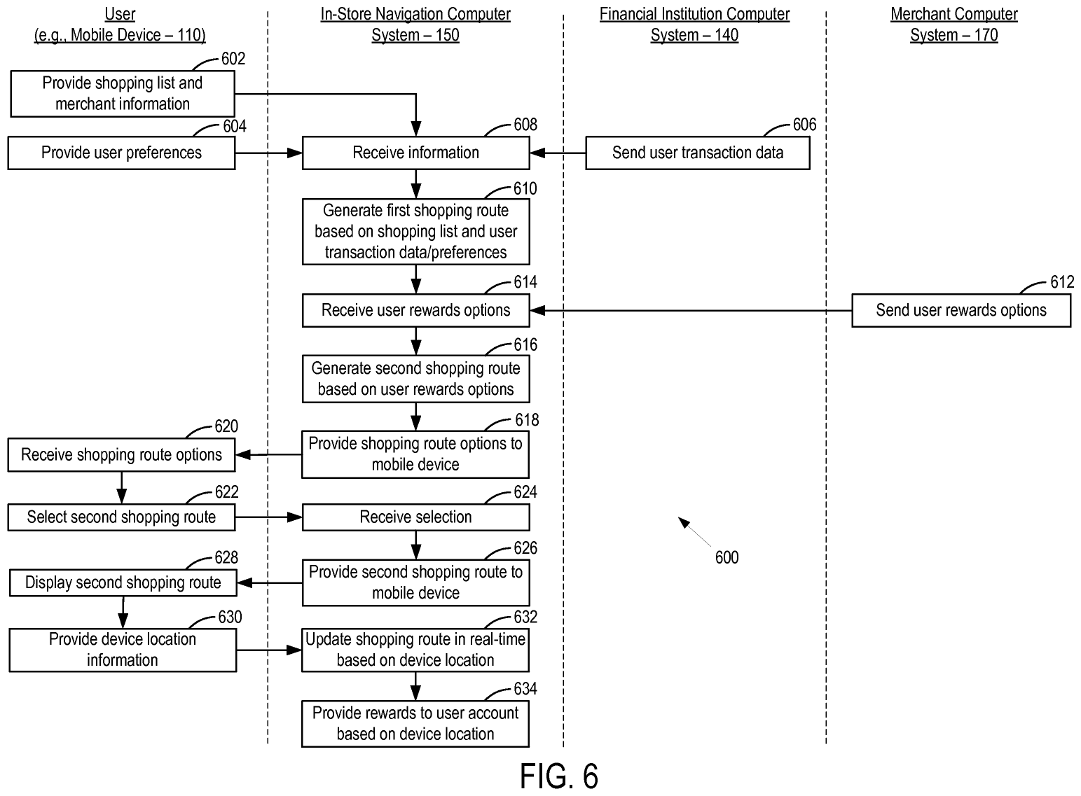

Referring now to FIG. 6, the process 600 is shown for providing a customized in-store shopping route to a user, including one or more user rewards, according to an example embodiment. The process 600 may include providing one or more customized in-store shopping routes for a user at a merchant location based on a user shopping list and user transaction data and preferences. In an example embodiment, the in-store shopping routes are customized based on available user rewards.

At 602 of the process 600, the user provides a user shopping list and merchant information to the in-store navigation computer system 150 using the mobile device 110. At 604, the user provides user preferences to the in-store navigation computer system 150 using the mobile device 110. At 606, the financial institution computer system 140 provides user transaction data to the in-store navigation computer system 150. The user transaction data is related to the financial account(s) held by the user and provided by the financial institution computer system 140. The user may authorize the financial institution computer system 140 to provide any user-related information to the in-store navigation computer system 150. At 608, the in-store navigation computer system 150 receives the information from the user and/or the financial institution computer system 140. The in-store navigation computer system 150 may also receive information from the merchant, including a layout or product information related to the merchant location, as well as any supplemental transaction data related to the user.

At 610, the in-store navigation computer system 150 generates an in-store shopping route (i.e., a first in-store shopping route) for routing the user within the merchant location. The first in-store shopping route is generated based on the user shopping list and layout information provided by the merchant computer system 170. The first in-store shopping route is intended to include a product location for each product listed on the user shopping list. The first in-store shopping route may be the most efficient route through the merchant location that passes through each of the product locations, as determined by the in-store navigation computer system 150. However, the first in-store shopping route is also based on the user transaction data and/or the user preferences received by the in-store navigation computer system 150, which may include any user data or preferences described herein. Therefore, the first in-store shopping route may incorporate user preferences and transaction data to provide a more preferable route to the user (i.e., rather than the fastest route through the merchant location). For instance, the user may weight various factors related to the shopping experience and provide the weighted factors to the in-store navigation computer system 150 as user preferences. The first in-store shopping route (or any other shopping route(s)) may then be generated by the in-store navigation computer system 150 based on the weighted factors. Such factors may include shopping time, distance traveled, number or type of departments or stores visited, overall financial cost, payment or checkout type, cart used, restroom or restaurant stops, user rewards earned, or any other factors described herein.

As an example, based on the user preferences and transaction data, the in-store navigation computer system 150 may determine that the user frequently shops at health food stores and belongs to a gym. Alternatively, the user may indicate to the in-store navigation computer system 150 that health and fitness is a preferred category of store or department. Based on this determination, the in-store navigation computer system 150 may generate the first in-store shopping route to route the user through the produce section or health supplement aisle of a grocery store location. In this example, the first in-store shopping route may not be the most efficient possible route to locate all products from the shopping list, but the route may meet one or more user preferences or otherwise provide a service to the user. The in-store navigation computer system 150 may indicate to the user that the route has been customized to include a trip through the noted section or department when providing the first in-store shopping route to the user.

At 612, the merchant computer system 170 sends user rewards options to the in-store navigation computer system 150. The in-store navigation computer system 150 may also receive user rewards options from the financial institution computer system 140. The user rewards options may include any user rewards that are available to the user via the merchant computer system 170 (i.e., via the merchant) or the financial institution computer system 140. The available user rewards may include various offers, discounts, rebates, merchandise, rewards points, or other value provided to the user in exchange for a merchant or financial institution-specified user action. For instance, user rewards may be provided to the user in exchange for purchasing a specified product, selecting and/or following a particular shopping route at the merchant location, viewing a specified product or display at the merchant location, visiting a specified department or store at the merchant location, being within the merchant location for a predetermined period of time, or using a specified payment method to make a purchase. The merchant computer system 170 and/or the financial institution computer system 140 may also provide the particular requirements to obtain the user rewards when sending the user rewards options to the in-store navigation computer system 150.

The user rewards options may be generated or provided based on the user. For instance, the in-store navigation computer system 150 may provide user information, such as the user shopping list, to the merchant computer system 170 and/or the financial institution computer system 140 prior to receiving the rewards options. The merchant computer system 170 and/or the financial institution computer system 140 may then determine one or more user rewards options based on the user information. As an example, the merchant computer system 170 may be provided with the user shopping list. Based on the user shopping list, the merchant computer system 170 may offer a user reward for purchasing a substitute product in place of a product on the user shopping list. The substitute product may be substantially similar to the original product, but provide an additional benefit to the merchant when purchased. In this case, the user reward may also be provided by the manufacturer or producer of the substitute product and transferred to the user via the merchant computer system 170 and/or the financial institution computer system 140.

The user rewards options may also be generated or provided based on an in-store shopping route. As an example, the in-store navigation computer system 150 may provide the first in-store shopping route to the merchant computer system 170. The merchant computer system 170 may then offer a user reward for traveling to one or more locations not located on the shopping route. For instance, the merchant computer system 170 may offer a user reward for traveling through a department or section of the merchant location in which the user is likely to make an additional (e.g., impulse) purchase. The department or section of the merchant location may be selected based on the user transaction data and/or the user profile. For instance, shared user transaction data (e.g., from the financial institution computer system 140, from the merchant computer system 170, etc.) may indicate that the user has purchased a particular item in the past and may be likely to purchase the item during the current shopping trip if directed to its location. The merchant computer system 170 may then offer a user reward for traveling to the selected location.

The financial institution computer system 140 may also generate one or more user rewards options. For instance, the financial institution computer system 140 may offer a user reward for completing the user shopping list, traveling to all locations on the selected in-store shopping route, using a payment account provided by the financial institution computer system 140 to purchase the selected products, or performing any other action that may provide a benefit to the financial institution computer system 140. At 612, the in-store navigation computer system 150 receives the user rewards options from the merchant computer system 170 and/or the financial institution computer system 140.

At 616, the in-store navigation computer system 150 generates a customized in-store shopping route (i.e., a second in-store shopping route) based on one or more of the user rewards offers. The second in-store shopping route includes the locations of the first in-store shopping route, but is customized to include the locations related to the one or more user rewards offers. The one or more user rewards offers included in the second in-store shopping route may be selected by the user or determined by the in-store navigation computer system 150 based on the user profile. In an example embodiment, the second in-store shopping route is the most efficient (i.e., fastest) route for traveling to all of the product locations while still performing the required user actions to achieve the associated user rewards.

At 618, the in-store navigation computer system 150 provides both the first and second in-store shopping routes (i.e., the shopping route options) to the user (i.e., the mobile device 110). In other embodiments, the in-store navigation computer system 150 may provide any number of shopping route options to the user, with each option including one or more conditions to be met by the user to obtain an associated user reward. At 620, the user receives the shopping route options, which may be displayed to the user via the mobile device 110. For instance, the shopping route options may be provided to the user via the in-store navigation client application 124.

At 622, the user selects one of the shopping route options (i.e., the second in-store shopping route) using the mobile device 110. In other embodiments, the shopping route may be automatically selected by the in-store navigation computer system 150 based on the user profile. In these options, the user may have the option to approve the selected shopping route or request another option. At 624, the in-store navigation computer system 150 receives the selection from the mobile device 110. At 626, the in-store navigation computer system 150 provides the selected shopping route (i.e., the second in-store shopping route) to the user. At 628, the mobile device 110 displays the selected shopping route to the user. At 630, the mobile device 110 provides device location information to the in-store navigation computer system 150. At 632, the in-store navigation computer system 150 updates the selected shopping route in real-time based on the device location. For instance, the in-store navigation computer system may provide turn-by-turn directions to the user in real-time based on the location of the mobile device 110 within the merchant location.

At 634, the in-store navigation computer system 150 provides rewards to a rewards account of the user based on the device location. The rewards may be provided via the financial institution computer system 140. For instance, the selected shopping route may include a user reward offer that triggers a user reward when the user (i.e., the mobile device 110) reaches a specified location within the merchant location. When the specified location is reached, which is determined based on the location of the mobile device 110, the in-store navigation computer system 150 may provide the associated user reward to the user. The user reward may be deposited into a rewards or financial account of the user, provided using the in-store navigation client application 124, or otherwise provided to the user.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A computer-implemented method performed by one or more processors of an in-store navigation computer system, the method comprising:
receiving, by the in-store navigation computer system, a shopping list from a user of the in-store navigation computer system, wherein the shopping list includes at least one product available for purchase at a merchant location;
receiving, by the in-store navigation computer system, product location information for the merchant location;
generating, by the in-store navigation computer system, a shopping route for the user at the merchant location based on the shopping list and the product location information;
providing, by the in-store navigation computer system, the shopping route as a navigation display to a mobile device of the user;
receiving, by the in-store navigation computer system, location information from the mobile device; and
updating, by the in-store navigation computer system, the navigation display on the mobile device based on the location information received from the mobile device.

2. The method of claim 1, further comprising:
receiving, by the in-store navigation computer system, transaction data related to a financial account held by the user; and
updating, by the in-store navigation computer system, the shopping list based on the transaction data.

3. The method of claim 1, wherein the shopping list is received from the mobile device of the user.

4. The method of claim 3, further comprising:
determining, by the in-store navigation computer system, the merchant location; and
prior to determining the merchant location, receiving, by the in-store navigation computer system, location information for the mobile device;
wherein the merchant location is determined based on the shopping list and the location information for the mobile device.

5. The method of claim 1, further comprising:
receiving, by the in-store navigation computer system, a selected shopping route variable from the user;
wherein the shopping route is generated based on the selected variable.

6. The method of claim 1, further comprising:
receiving, by the in-store navigation computer system, a selected location within the merchant location from the user along with the shopping list;
wherein the shopping route is generated to include the selected location.

7. The method of claim 1, further comprising:
determining, by the in-store navigation computer system, that a product location is reached by the user based on the location information received from the mobile device; and
providing, by the in-store navigation computer system, a reward to the user when the product location is reached.

8. A computer-implemented method performed by one or more processors of an in-store navigation computer system, the method comprising:
receiving, by the in-store navigation computer system, a shopping list from a user having one or more financial accounts provided by a financial institution computer system, wherein the shopping list includes a plurality of products available for purchase at a merchant location;
receiving, by the in-store navigation computer system, transaction data related to the one or more financial accounts from the financial institution computer system;
determining, by the in-store navigation computer system, a recommended product based on the shopping list and the transaction data, wherein determining the recommended product comprises:
determining, based on the transaction data, a first product that has been purchased by the user from another location;
generating, by the in-store navigation computer system, a customized shopping list by adding the recommended product to the shopping list received from a mobile device of the user;
receiving, by the in-store navigation computer system, product location information for the merchant location;
generating, by the in-store navigation computer system, a shopping route for the user at the merchant location based on the customized shopping list and the product location information, wherein a respective product location for each of the plurality of products included in the shopping list represents a checkpoint on the shopping route;
providing, by the in-store navigation computer system, the shopping route as a display to the mobile device of the user;
receiving, by the in-store navigation computer system, location information from the mobile device of the user at a first checkpoint on the shopping route, the location information comprising at least one beacon identifier received by the mobile device from a locator beacon within the merchant location;
determining, by the in-store navigation computer system, an approximate location of the mobile device by correlating the beacon identifier with a beacon map;
selecting, by the in-store navigation computer system, based on the transaction data, a section of the merchant location that is not on the shopping route received by the in-store navigation computer system, wherein the transaction data indicates that the user has previously purchased an item in the section of the merchant location;
determining, by the in-store navigation computer system, to offer one or more gift cards to the user at the merchant location for the user visiting the section of the merchant location;
depositing, by the in-store navigation computer system, the one or more gift cards to a rewards account of the user when the user reaches the section of the merchant location within the merchant location, based on the approximate location of the mobile device;
updating, by the in-store navigation computer system, the shopping route based on the location information received at the first checkpoint and the approximate location of the mobile device; and
providing, by the in-store navigation computer system, the updated shopping route to the mobile device of the user in real-time.

9. (canceled)

10. (canceled)

11. The method of claim 8, wherein the shopping route includes an in-store location for each of the products listed on the customized shopping list.

12. The method of claim 8, further comprising:
prior to generating the shopping route, sending, by the in-store navigation computer system, the customized shopping list to the mobile device of the user; and
receiving, by the in-store navigation computer system, an indication from the mobile device of the user that the customized shopping list is approved by the user.

13. The method of claim 8, wherein determining the recommended product further comprises:
based on the transaction data, determining that the recommended product was previously purchased by the user, but that the recommended product has not been purchased by the user within a predetermined time period; and
determining that the recommended product is not included on the shopping list received from the mobile device of the user.

14. The method of claim 13, wherein the predetermined time period is determined based on an expiration or consumption period of the recommended product.

15. The method of claim 8, further comprising determining the recommended product by:
based on the transaction data, determining a product that was previously purchased by the user; and
based on a user profile, determining a substitute product that is substantially similar to the product and available for purchase at the merchant location.

16. A computer-implemented method performed by one or more processors of an in-store navigation computer system, the method comprising:
receiving, by the in-store navigation computer system, a shopping list from a user having an account with the in-store navigation computer system, wherein the shopping list includes a plurality of products available for purchase at a merchant location;
receiving, by the in-store navigation computer system, a user preference from the user;
determining, by the in-store navigation computer system, a product to be substituted for one or more of the plurality of products listed on the shopping list based on the user preference, wherein the substitute product is available for purchase at the merchant location and provides a benefit to the user that is related to the user preference;
generating, by the in-store navigation computer system, a customized shopping list by substituting the substitute product for the one or more products listed on the shopping list;
receiving, by the in-store navigation computer system, product location information for the merchant location; and
generating, by the in-store navigation computer system, a shopping route for the user at the merchant location based on the customized shopping list and the product location information.

17. The method of claim 16, further comprising:
providing, by the in-store navigation computer system, the shopping route as a display to the mobile device of the user.

18. The method of claim 16, further comprising:
receiving, by the in-store navigation computer system, location information from the mobile device of the user;
updating, by the in-store navigation computer system, the shopping route based on the location information; and
providing, by the in-store navigation computer system, the updated shopping route to the mobile device of the user in real-time.

19. The method of claim 16, wherein the shopping route includes the in-store location of each of the products listed on the customized shopping list.

20. The method of claim 16, further comprising:
prior to generating the shopping route, sending, by the in-store navigation computer system, the customized shopping list to the mobile device of the user; and
receiving, by the in-store navigation computer system, an indication from the mobile device of the user that the customized shopping list is approved by the user.

21. The method of claim 16, wherein the user preference comprises a user budget, and wherein determining the substitute product further comprises:
determining that the cost of the plurality of products listed on the shopping list received from the user exceed the user budget; and
determining that replacing the one or more products with the substitute product will lower the cost so that the user budget is not exceeded.

22. The method of claim 21, wherein the user budget is based on a designated time period that includes prior transactions, and wherein the in-store navigation computer system determines that the cost of the plurality of products would exceed the user budget based on the transaction data and the one or more user preferences.

23. The method of claim 21, further comprising:
sending, by the in-store navigation computer system, an alert to the mobile device when the cost of the plurality of products listed on the shopping list received from the user will exceed the user budget.

24. A computer-implemented method performed by one or more processors of an in-store navigation computer system, the method comprising:
receiving, by the in-store navigation computer system, a shopping list from a user having one or more financial accounts provided by the financial institution computer system, wherein the shopping list includes a plurality of products available for purchase at a merchant location;
receiving, by the in-store navigation computer system, product location information for the merchant location, wherein the product location information includes an in-store location for each of the plurality of products listed on the shopping list;
generating, by the in-store navigation computer system, a first shopping route for the user based on the shopping list and the product location information;
determining, by the in-store navigation computer system, a user rewards offer based on the first shopping route, wherein the user rewards offer includes an offer to provide a reward to the user in exchange for a requested user action;
generating, by the in-store navigation computer system, a second shopping route for the user based on the first shopping route and the requested user action; and
providing, by the in-store navigation computer system, the first and second shopping routes to a mobile device of the user as selectable options, including providing an indication of the available reward and the requested user action.

25. The method of claim 24, further comprising:
receiving, by the in-store navigation computer system, a selection of the second shopping route from the mobile device of the user;
providing, by the in-store navigation computer system, the second shopping route as a navigation display to the mobile device of the user.

26. The method of claim 25, further comprising:
receiving, by the in-store navigation computer system, location information from the mobile device;
determining, by the in-store navigation computer system, that the user action has been performed by the user based on the location information; and
providing, by the in-store navigation computer system, the reward to the user based on determining that the user action has been performed.

27. The method of claim 26, further comprising:
updating, by the in-store navigation computer system, the second shopping route based on the location information; and
providing, by the in-store navigation computer system, the updated second shopping route to the mobile device of the user in real-time.

28. The method of claim 24, wherein the user rewards offer is based on an offer provided by a merchant computer system associated with the merchant location, and wherein the user action is intended to provide additional value to the merchant computer system.

29. The method of claim 24, wherein the reward is determined by the in-store navigation computer system based on a user preference provided by the user.

30. The method of claim 24, wherein the user action includes purchasing a specified product that is available at the merchant location and not included on the shopping list that is received from the user.

31. The method of claim 24, wherein the user action includes traveling to a specified area of the merchant location that is not included as part of the first shopping route.

32. (canceled)

33. The method of claim 8, wherein the shopping list is received from the mobile device of the user.

34. The method of claim 8, further comprising:
determining a user budget;
determining that a total cost of the plurality of products listed on the shopping list received from the user exceed the user budget; and
determining that replacing the one or more products with a substitute product will lower the cost so that the user budget is not exceeded.

35. The method of claim 34, wherein the user budget is based on a designated time period that includes prior transactions, and wherein the in-store navigation computer system determines that the cost of the plurality of products would exceed the user budget based in part on the transaction data for the designated time period.

36. The method of claim 34, further comprising:
sending, by the in-store navigation computer system, an alert to the mobile device of the user to indicate that the total cost of the plurality of products listed on the shopping list received from the user exceeds the user budget.

37. The method of claim 8, wherein determining to offer one or more gift cards to the user further comprises determining, by the in-store navigation computer system, the one or more rewards based on an offer provided to the in-store navigation computer system by a merchant computer system associated with the merchant location.

38. The method of claim 8, wherein determining to offer one or more gift cards to the user further comprises determining, by the in-store navigation computer system, the one or more rewards based on an offer provided to the in-store navigation computer system by an entity associated with a product located in the merchant location.

39. The method of claim 8, wherein depositing, in addition to the one or more gift cards, one or more rewards comprising at least one of a discount, a rewards point, or cash.

40. The method of claim 8, wherein selecting the section of the merchant location is further based on the section being a location in which the user is likely to make an impulse purchase of the item the user has previously purchased, as indicated in the transaction data.
